(19) United States
(12) Patent Application Publication
(10) Pub. No.: US 2026/0083062 A1
(43) Pub. Date: Mar. 26, 2026

(54) LAWN MOWER WITH GRASS DIRECTING SYSTEM

(71) Applicant: THE TORO COMPANY, Bloomington, MN (US)

(72) Inventors: Alexander Steven Frick, Farmington, MN (US); Ryan J. Volovsek, Inver Grove Heights, MN (US); Gregory S. Janey, Excelsior, MN (US)

(21) Appl. No.: 19/110,264

(22) PCT Filed: Sep. 22, 2023
(86) PCT No.: PCT/US2023/033460

§ 371 Date: Mar. 10, 2025

Related U.S. Application Data
(60) Provisional application No. 63/411,294, filed on Sep. 29, 2022.

(51) Int. Cl. A01D 57/01; A01D 34/00; A01D 101/00

(52) U.S. Cl. CPC A01D 57/01; A01D 34/008; A01D 2101/00

(57) ABSTRACT

The present invention relates to an autonomous lawn mower (100) including a cutting blade assembly (120) supported by a housing (102). The assembly includes at least one selectively-activated cutting blade (126), where the cutting blade assembly is adapted to cut grass along a cutting path (154) defining a cut edge (155, 157) located at a first distance (140, 142) measured transversely from the longitudinal axis (2) of the housing. The mower also includes a grass directing system (200) that includes at least one grass gatherer (202a, 202b) located forward of the cutting blade assembly, where the at least one grass gatherer is adapted to engage grass blades such that one or more of the grass blades are made to intersect a cutting plane defined by the cutting blade assembly and bounded by the cutting path so that the grass blades are cut by the cutting blade assembly.

This application claims priority to and/or the benefit of U.S. Provisional Patent Application No. 63/411,294, filed Sep. 29, 2022, which is incorporated herein by reference in its entirety.

Embodiments of the present disclosure relate to lawn mowers and, more particularly, to systems and methods for directing bent blades of grass to a position where the blades may be more effectively cut by a rotating cutting blade of the lawn mower.

### BACKGROUND

Lawn and garden machines are known for performing a variety of tasks. For instance, powered lawn mowers are used by both homeowners and professionals alike to maintain turf areas within a property or yard.

Mowers that autonomously perform a grass cutting function are also known. Autonomous mowers typically include a cutting deck having one or more cutting blades. One or more battery-powered electric motors typically power both the cutting blades and a mower propulsion system.

Autonomous mowers by definition may operate without direct operator involvement. Due to this lack of direct operator interaction, such mowers often position the cutting blades sufficiently inboard from an edge or sidewall of the cutting deck to minimize, for instance, inadvertent contact of the blades with foreign objects.

### SUMMARY

This disclosure includes without limitation the following clauses:
Clause 1: An autonomous lawn mower having a housing that includes a downwardly extending sidewall, where the housing extends along a longitudinal axis between a front end and a rear end of the mower; ground support members adapted to support the housing upon a ground surface of a work region in which the mower operates; and a cutting blade assembly supported by the housing and including at least one selectively-activated cutting blade, where the cutting blade assembly is adapted to cut grass along a cutting path that defines a cut edge located at a first distance measured transversely from the longitudinal axis of the housing. The lawn mower further includes a grass directing system located proximate the cutting blade assembly. The grass directing system includes at least one grass gatherer located forward of the cutting blade assembly, where the at least one grass gatherer is adapted to engage grass blades such that one or more of the grass blades are made to intersect a cutting plane defined by the cutting blade assembly and bounded by the cutting path so that the one or more grass blades are cut by the cutting blade assembly.
Clause 2: The lawn mower of Clause 1, where the at least one grass gatherer includes at least one finger that spins within a plane parallel to the ground surface.
Clause 3: The lawn mower of Clause 2, where the at least one finger includes one or more brush bristles.
Clause 4: The lawn mower of Clause 2, where the at least one finger includes one or more tines.
Clause 5: The lawn mower of Clause 1, where the at least one grass gatherer includes a roller.
Clause 6: The lawn mower of Clause 5, where the roller is adapted to rotate about a roller axis that is substantially parallel to the ground surface and substantially orthogonal to the longitudinal axis.
Clause 7: The lawn mower of any one of Clauses 5-6, where the roller includes a textured surface.
Clause 8: The lawn mower of any one of Clauses 1-4, where the grass gatherer is adapted to rotate about a gatherer axis.
Clause 9: The lawn mower of Clause 8, where the gatherer axis is substantially orthogonal to the ground surface.
Clause 10: The lawn mower of Clause 1, where the at least one grass gatherer of the grass directing system includes a first grass gatherer and a second grass gatherer, where the first grass gatherer rotates about a first gatherer axis and the second grass gatherer rotates about a second gatherer axis.
Clause 11: The lawn mower of Clause 10, where the first grass gatherer rotates about the first gatherer axis in a first direction and the second grass gatherer rotates about the second gatherer axis in a second direction different from the first direction.
Clause 12: The lawn mower of Clause 10, where the first grass gatherer is independently controllable from the second grass gatherer.
Clause 13: The lawn mower of any one of Clauses 1-12, where the grass directing system further includes a vacuum module that is adapted to further engage the grass blades such that one or more additional grass blades are made to intersect the cutting plane so that the one or more additional grass blades are cut by the cutting blade assembly.
Clause 14: The lawn mower of any one of Clauses 1-13, where the cutting blade assembly is operatively connected to a propulsion motor that is further operatively connected to the ground support members.
Clause 15: The lawn mower of Clause 14, where the grass directing system is operatively connected to the propulsion motor.
Clause 16: The lawn mower of Clause 14, where the grass directing system is operatively connected to an implement motor.
Clause 17: The lawn mower of any one of Clauses 1-13, where the cutting blade assembly and the grass directing system are operatively connected to a cutting mower and the ground support members are operatively connected to a propulsion motor.
Clause 18: The lawn mower of any one of Clauses 1-17, where the cutting blade assembly and grass directing system are independently controllable.
Clause 19: The lawn mower of any one of Clauses 1-18, where a height between the at least one grass gatherer and the ground surface is adjustable.
Clause 20: The lawn mower of Clause 1, where the at least one grass gatherer is adapted to engage grass blades along an engagement path defining an engagement edge located at a second distance measured transversely from the longitudinal axis, where the second distance is less than the first distance of the cut edge.
Clause 21: A lawn mower that includes a housing having a downwardly extending sidewall, where the housing extends along a longitudinal axis between a front end and a rear end of the lawn mower; ground support members adapted to support the housing upon a ground surface of a work region in which the mower operates; and a cutting motor connected to the housing. The lawn mower further includes a cutting blade assembly supported by the housing and operatively connected to the cutting motor, where the cutting blade assembly includes at least one selectively-activated cutting blade, and where the cutting blade assembly is adapted to cut grass along a cutting path that defines a cut edge located at a first distance measured transversely from the longitudinal axis of the housing; and a grass directing system located proximate the cutting blade assembly and operatively connected to the cutting motor. The grass directing system includes a first grass gatherer and a second grass gatherer, where the first and second grass gatherers are adapted to engage grass blades such that one or more of the grass blades are made to intersect a cutting plane defined by the cutting blade assembly and bounded by the cutting path so that the one or more grass blades are cut by the cutting blade assembly.
Clause 22: The lawn mower of Clause 21, where at least one of the first grass gatherer or second grass gatherer includes at least one finger that spins within a plane parallel to the ground surface.
Clause 23: The lawn mower of Clause 22, where the at least one finger includes one or more brush bristles.
Clause 24: The lawn mower of Clause 22, where the at least one finger includes one or more tines.
Clause 25: The lawn mower of any one of Clauses 21-24, where the first grass gatherer is adapted to rotate about a first gatherer axis and the second grass gatherer is adapted to rotate about a second gatherer axis.
Clause 26: The lawn mower of Clause 25, where at least one of the first gatherer axis or second gatherer axis is substantially orthogonal to the ground surface.
Clause 27: The lawn mower of any one of Clauses 25-26, where the first grass gatherer rotates about the first gatherer axis in a first direction and the second grass gatherer rotates about the second gatherer axis in a second direction different from the first direction.
Clause 28: The layer mower of any one of Clauses 21-27, where the ground support members are operatively connected to a propulsion motor.
Clause 29: The lawn mower of any one of Clauses 21-28, where the first grass gatherer is independently controllable from the second grass gatherer.
Clause 30: The lawn mower of any one of Clauses 21-29, where the grass direction system further includes a vacuum module that is adapted to further engage the grass blades such that one or more additional grass blades are made to intersect the cutting plane so that the one or more additional grass blades are cut by the cutting blade assembly.
Clause 31: The lawn mower of any one of Clauses 21-30, where the cutting blade assembly and grass directing system are independently controllable.
Clause 32: The lawn mower of any one of Clauses 21-31, where a height between at least one of the first grass gatherer or second grass gatherer and the ground surface is adjustable.
Clause 33: The lawn mower of Clause 32, further including a height adjustment motor operatively connected to at least one of the first grass gatherer or second grass gatherer.
Clause 34: The lawn mower of any one of Clauses 21-33, where the first grass gatherer is adapted to engage grass blades along an engagement path defining an engagement edge located at a second distance measured transversely from the longitudinal axis, where the second distance is less than the first distance of the cut edge.
Clause 35: The lawn mower of Clause 34, where the second grass gatherer is adapted to engage grass blades along a second engagement path defining an engagement edge located a third distance measured transversely from the longitudinal axis, where the third distance is less than the first distance of the cut edge.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a schematic side view of one embodiment of an autonomous grounds maintenance machine, e.g., lawn mower, in accordance with embodiments of the present disclosure;

FIG. 2 is a schematic side view of the autonomous grounds maintenance machine of FIG. 1;

FIG. 3 is a bottom plan view of the autonomous grounds maintenance machine of FIG. 1 with front ground support members removed for explanatory purposes;

FIG. 4 is the bottom plan view of the autonomous grounds maintenance machine of FIG. 1, including the front ground support members, where grass gatherers of a grass directing system of the autonomous grounds maintenance machine have been removed for explanatory purposes;

FIG. 5 is a schematic side view of a grass gatherer of a grass directing system of the autonomous grounds maintenance machine of FIG. 1;

FIG. 6 is a schematic plan view of another embodiment of a grass gatherer that can be utilized with the grass directing system of the autonomous grounds maintenance machine of FIG. 1;

FIG. 7 is a schematic bottom plan view of another embodiment of an autonomous grounds maintenance machine that includes a grass directing system; and

FIG. 8 is a schematic front view of a portion of the autonomous grounds maintenance machine of FIG. 1.

The figures are rendered primarily for clarity and, as a result, are not necessarily drawn to scale. Moreover, various structure/components, including but not limited to fasteners, electrical components (wiring, cables, etc.), and the like, may be shown diagrammatically or schematically, or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” Further, the term “and/or” (if used) means one or all of the listed elements or a combination of any two or more of the listed elements. Still further, “i.e.” is used herein as an abbreviation for the Latin phrase id est, and means “that is,” while “e.g.” is used as an abbreviation for the Latin phrase exempli gratia and means “for example.”

Embodiments of the present disclosure are directed to autonomous working machines or vehicles (e.g., autonomous lawn mowers). Such machines may operate autonomously. For example, the vehicle may be an autonomous lawn mower having one or more cutting members or blades adapted to cut grass as the mower travels over the work region.

Unlike conventional autonomous mowers, however, mowers in accordance with embodiments of the present disclosure may further incorporate features that assist the cutting members in cutting grass. For example, in one more embodiments, an autonomous lawn mower can include a grass directing system that includes one or more grass gatherers located forward of the cutting members. At least one of the grass gatherers can be adapted to engage the grass blades such that one or more of the grass blades are made to intersect a cutting plane defined by the cutting blade assembly and bounded by the cutting path so that the one or more grass blades are cut by the cutting blade assembly.

As used herein, “property” is defined as a geographic region (such as a yard) circumscribed by a fixed property boundary within which the vehicle (e.g., mower) may perform work (e.g., mow grass). “Work region” is used herein to refer to those areas contained (or mostly contained) within the property boundary within which the vehicle will perform work. For example, work regions could be defined by grass surfaces of a residential or commercial property upon which an autonomous lawn mower will operate. A property may contain one or more work regions (e.g., a front yard area and a back yard area, or two yard areas separated by a sidewalk or driveway).

While described herein as a mower, such a configuration is exemplary only as systems and methods described herein may also have application to other autonomously operated vehicles including, for example, commercial turf products, other ground working vehicles (e.g., debris blowers/vacuums, aerators, material spreaders, snow throwers), as well as indoor working vehicles such as vacuums and floor scrubbers/cleaners.

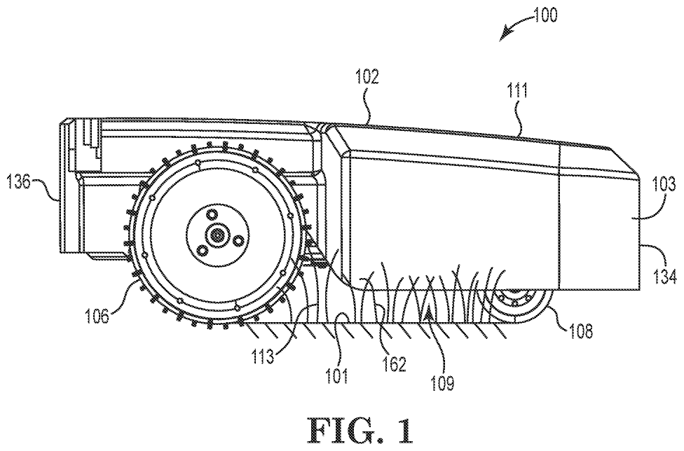

It is noted that the terms “have,” “includes,” “comprises” and variations thereof do not have a limiting meaning and are used in their open-ended sense to generally mean “including, but not limited to,” where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the vehicle (e.g., mower 100) is operating upon a ground surface 101 as shown in FIG. 1. These terms are used only to simplify the description, however, and not to limit the interpretation of any embodiment described.

As used herein, the terms “determine” and “estimate” may be used interchangeably depending on the particular context of their use, for example, to determine or estimate the presence and/or position of an object relative to the mower 100.

Still further, the suffixes “a” and “b” may be used throughout this description to denote various left-and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

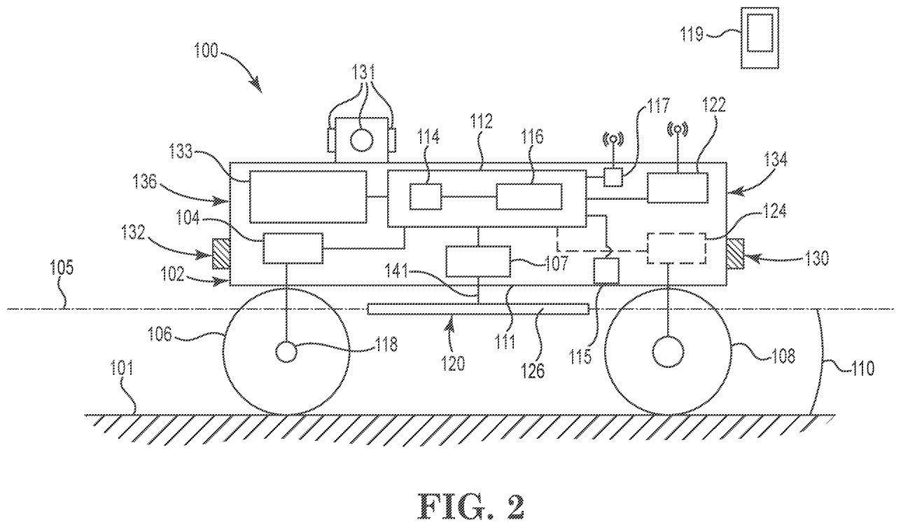

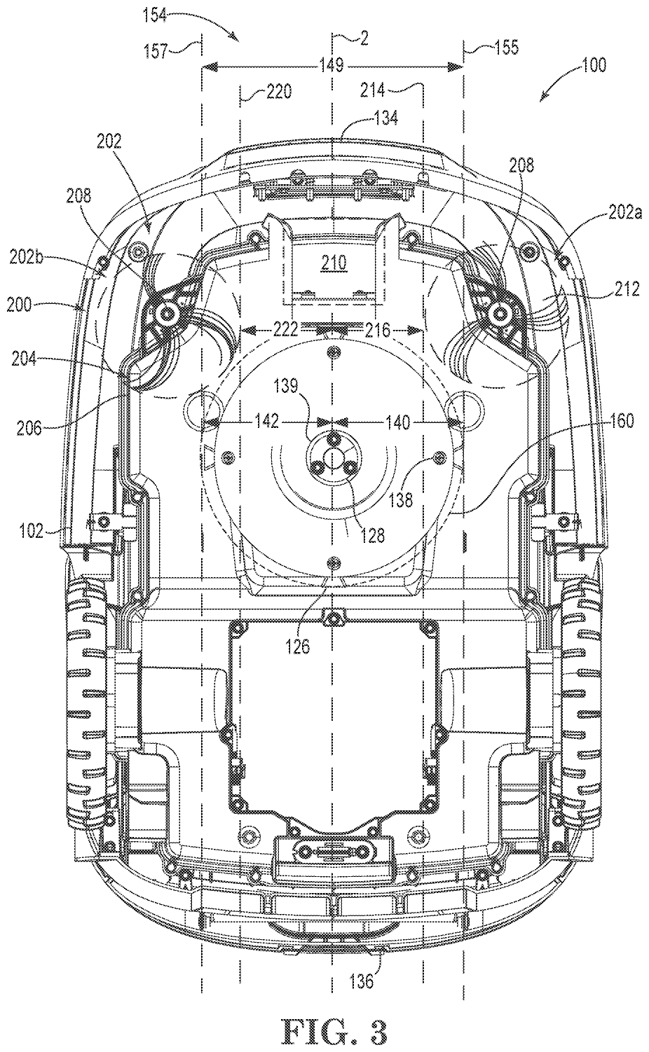

While the general construction of the autonomous working machine is not necessarily central to an understanding of embodiments of this disclosure, FIGS. 1-4 are various views of one example of an autonomous lawn mower 100, which may form part of a lawn mowing system (for simplicity of description, the mower 100 is illustrated schematically in FIG. 2). The mower 100 includes a housing 102 having a downwardly extending sidewall 103. As shown in FIG. 3, the housing 102 extends along a longitudinal axis 2 between a front end 134 and a rear end 136 of the mower 100. The mower 100 further includes ground support members 106, 108 that are adapted to support the housing 102 upon a ground surface 101 of a work region in which the mower operates, and a cutting blade assembly 120 supported by the housing and including at least one selectively-activated cutting blade 126. The cutting blade assembly 120 is adapted to cut grass 113 along a cutting path 154 defining a cut edge 155 located at a first distance 140 (FIG. 3) from the longitudinal axis 2 of the housing. The mower 100 further includes a grass directing system 200 (FIG. 3) located proximate the cutting blade assembly 120. The grass directing system 200 includes at least one grass gatherer 202 located forward of the cutting blade assembly 120. The at least one grass gatherer 202 is adapted to engage grass blades 162 (FIG. 1) such that one or more of the grass blades are made to intersect a cutting plane 105 (FIG. 2) defined by the cutting blade assembly 120 and bounded by the cutting path 154 so that the one or more grass blades are cut by the cutting blade assembly.

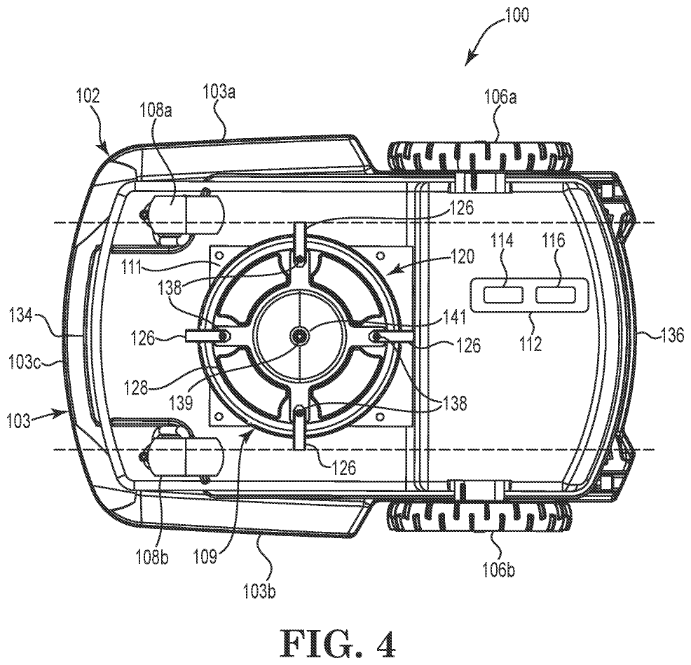

The housing 102 of the mower 100 can have any suitable dimensions and take any suitable shape. As shown in FIG. 4, the housing 102 may form an upper wall 111 and one or more downwardly extending sidewalls 103 (e.g., left sidewall 103a, right sidewall 103b, and front sidewall 103c (collectively sidewalls 103)) that form a cutting chamber 109. In one or more embodiments, some or all of the sidewalls 103 may be formed by a perimeter bump shroud that may be used to detect contact with obstacles. The transverse outer edges of the left and right sidewalls 103a-b may extend outwardly to or beyond a rear wheel track width of rear wheels 106 as shown.

The mower 100 may further include the ground support members 106, 108, such as wheels, rollers, or tracks adapted to support the housing 102 upon the ground surface 101 of the work region. In the illustrated embodiment, the ground support members 106, 108 include the one or more rear wheels 106 (e.g., left rear wheel 106a and right rear wheel 106b as shown in FIG. 4) and one or more front wheels 108 (e.g., left front wheel 108a and right front wheel 108b), that support the housing 102 in rolling engagement upon the ground surface 101, i.e., the front wheels 108 may support the front end 134 of the mower 100 while the rear wheels 106 support the rear end 136 of the mower. As used herein, the ground surface 101 is a theoretical ground plane defined by a plane that contacts at least three wheels 106, 108 of the mower 100. Grass blades 162 of grass 113 (FIG. 1) generally extend from the ground surface 101.

One or both rear wheels 106 may be powered or driven by a propulsion system (e.g., one or more electric propulsion or wheel motors 104 as shown in FIG. 2) adapted to propel the mower 100 over the ground surface 101. In one or more embodiments, the front wheels 108 may freely caster relative to the housing 102 (e.g., about vertical axes). In such a configuration, mower direction may be controlled via differential rotation of the two rear wheels 106 in a manner similar to a conventional zero-turn-radius (ZTR) riding mower. That is to say, the propulsion system may include separate wheel motors 104 for left and right rear wheels 106a, 106b so that speed and direction of each rear wheel may be independently controlled. In addition, or alternatively, the front wheels 108 could be actively steerable by the propulsion system (e.g., including one or more steer motors 124 as shown in FIG. 2) to assist with control of mower 100 direction, and/or could be driven by the propulsion system (i.e., to provide a front-wheel or all-wheel drive mower).

A powered implement (e.g., a grass cutting member, such as the cutting blade assembly 120) may be operatively connected to a cutting motor 107 (e.g., implement motor) carried by the housing 102. When the motors 107 and 104 are activated or energized, the mower 100 may be propelled over the ground surface 101 such that vegetation (e.g., grass blades 162) over which the mower passes is cut by the cutting blade assembly 120. While illustrated in FIGS. 1-4 as using only a single cutting blade assembly 120 and cutting motor 107, mowers incorporating multiple cutting blade assemblies, powered by a single or multiple motors, are possible within the scope of this disclosure. Moreover, while described herein in the context of having conventional cutting “blades,” other cutting members including, for example, disks, nylon string or line elements, knives, cutting reels, etc., are certainly possible without departing from the scope of this disclosure. Accordingly, the term “blade” as used herein may include any acceptable vegetation cutting member without departing from the scope of this disclosure. Still further, embodiments combining various cutting elements, e.g., a rotary blade and a string trimmer, are also contemplated. In one or more embodiments, the cutting blade assembly 120 can be operatively connected to the propulsion motor 104.

One or more cutting blade assemblies 120 may be included, and each such assembly may have at least one selectively-activated cutting blade. For example, each cutting blade assembly 120 can include a plurality of cutting blades 126 (e.g., four cutting blades) attached to a disk 128 as shown in FIG. 4. In one or more embodiments, each of the cutting blades 126 may be pivotally attached to the disk 128 by a pin or fastener 138. The disk 128 may be attached, directly or indirectly, to an output shaft 141, by a fastener 139. The output shaft 141 connects the disk 128 to the cutting motor 107 or propulsion motor 104 using any suitable technique.

During operation, the output shaft 141 rotates the cutting blade assembly 120 at a speed sufficient to permit the blades 126 to sever grass 113 and other vegetation over which the housing 102 passes. By pivotally connecting each cutting blade 126 to the rotating disk 128, the cutting blades are capable of incurring blade strikes against various objects (e.g., rocks, tree roots, etc.) without causing excessive damage to the blades, blade assembly 120, shaft 141, or motor 107.

The mower 100 may be adapted to operate (e.g., cut grass) autonomously as shown in FIG. 2. The cutting blade assembly 120 may be located inboard of the sidewalls 103 of the mower 100 as shown in FIGS. 3-4. That is, a blade tip circle 160 (the cutting diameter defined by outer tips of the blades 126 of the blade assembly 120 as shown in FIG. 3)) may be spaced-apart from one sidewall 103 (e.g., from the left sidewall 103a/trim edge) by a first distance and, of course, by a corresponding distance from the opposite sidewall (e.g., the right sidewall 103b). In one or more embodiments, these distances may be equal to one another and may be selected to locate the cutting blade assembly 120 centrally along the longitudinal axis 2 of the mower as shown in FIG. 3.

In one or more embodiments, the mower 100 is adapted to autonomously cut grass along the cutting path 154 defining the cut edge 155 located at the first distance 140 from the longitudinal axis 2 (FIG. 3) utilizing the cutting blade assembly 120. The first distance 140 can be any suitable distance. The cutting blade assembly 120 can further be adapted to autonomously cut grass along the cutting path 154 that also defines a second cut edge 157 located at the second distance 142 from the longitudinal axis 2. As a result, the assembly 120 is adapted to provide a cutting width 149 as measured between the cut edge 155 and the second cut edge 157. The cutting width 149 can be any suitable width. In one or more embodiments, the cutting blade assembly 120 can be adapted to cut grass in the cutting plane 105 (FIG. 2) defined by one or more of the blades 126 of the cutting blade assembly. As used herein, the term “cutting plane” means a plane that is defined by cutting edges of one or more of the cutting blades 126 and bounded by the cut edge 155 and second cut edge 157, i.e., the cutting plane 105 is bounded by the cutting path 154 such that it is a bounded plane. The cutting plane 105 can be disposed such that it forms any suitable angle 110 (i.e., a rake angle) with the ground surface 101, e.g., no greater than 10 degrees.

The mower 100 can also include the grass directing system 200 located proximate the cutting blade assembly 120. The grass directing system 200 includes at least one grass gatherer 202 disposed in any suitable location relative to the cutting blade assembly 120 and the ground support members 108. In one or more embodiments, the grass gatherers 202 can be disposed forward of the cutting blade assembly 120 as shown in FIG. 3, which is a bottom plan view of the mower 100 with the front ground support members 108 removed for clarity. As used herein, the phrase “forward of the cutting blade assembly” means that a closest distance between the grass gatherer 202 (i.e. the first or second grass gatherer 202a-b) and the front end 134 of the housing 102 as measured along the longitudinal axis 2 is less than a closest distance between the cutting blade assembly 120 and the front end of the housing as also measured along the longitudinal axis. In one or more embodiments, the grass gatherer 202 is disposed such that it does not contact the grass blade assembly 120. In one or more embodiments, the grass gatherer 202 can be disposed such that it overlaps with the cutting blade assembly 120 in a plane parallel to the ground surface 101 while still not contacting the cutting blade assembly. In one or more embodiments, the grass gatherer 202 does not overlap with the cutting blade assembly 120 in the plane parallel to the ground surface as shown, e.g., in FIG. 3.

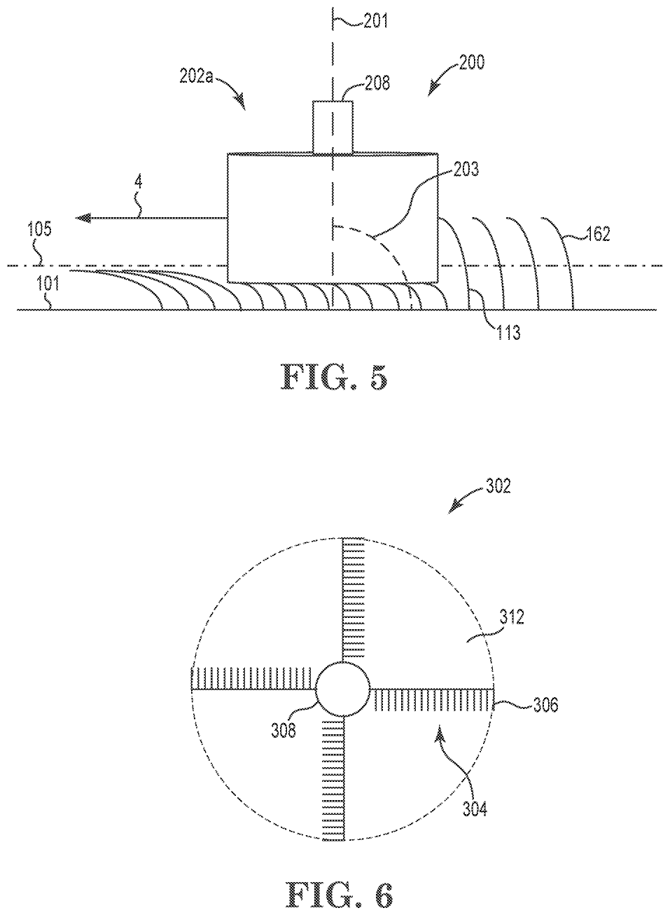

While the grass directing system 200 of the mower 100 includes a first grass gatherer 202a and a second grass gatherer 202b (collectively referred to as grass gatherers 202), the grass directing system can include any suitable number of grass gatherers disposed in any suitable positions forward of the grass cutting system 120. Each grass gatherer 202 can be adapted to engage grass blades 162 such that one or more of the grass blades are made to intersect the cutting plane 105 defined by the cutting blade assembly 120 and bounded by the cutting path 154 so that the one or more grass blades are cut by the cutting blade assembly. For example, as shown in FIG. 5, which is a schematic side view of the first grass gatherer 202a of the grass directing system 200, the grass gatherer is adapted to engage grass blades 162. As the mower 100 travels in direction 4, the grass gatherer 202a engages one or more grass blades 162, e.g., by straightening, bending, or elongating the blades.

The grass gatherers 202 can include any suitable element or component that is adapted to engage the grass blades 162 as described herein. In one more embodiments, at least one of the grass gatherers 202 includes at least one finger 204 (FIG. 3). Such grass gatherer 202 can include any suitable number of fingers 204. Further, each finger 204 of the grass gatherer 202 can be the same finger. In one or more embodiments, one or more fingers 204 of the grass gatherer 202 can be different from one or more additional fingers of the grass gatherer, e.g., a different shape, different dimensions, include different materials, etc. The fingers 204 can be connected to a hub or shaft 208 using any suitable technique. Each finger 204 can include any suitable element or component. For example, the fingers 204 of the grass gatherers 202 can include one or more brush bristles 206 having any suitable dimensions. Further, the bristles 206 can include any suitable material.

In one or more embodiments, the fingers 204 are adapted to spin within a plane 212. The plane 212 can form any suitable angle with the ground surface 101. As shown in FIG. 5, the grass gatherer 202a is adapted to rotate about a gatherer axis 201 that extends through the shaft 208 that is adapted to connect the grass gatherer to the housing 102 or a motor (e.g., motor 107) connected to the housing. The gatherer axis 201 can form any suitable angle 203 with the ground surface 101. In one or more embodiments, the gatherer axis 201 is substantially orthogonal to the ground surface 101. As used herein, the term “substantially orthogonal” means that the angle 203 formed between an axis and the ground surface 101 or other axis (e.g., longitudinal axis) is at least 85 degrees and no greater than 95 degrees.

In one or more embodiments, the fingers 204 can include one or more tines. For example, FIG. 6 is a schematic plan view of another embodiment of a grass gatherer 302. All design considerations and possibilities described herein regarding the grass gatherer 202 of FIGS. 3 and 5 apply equally to the grass gatherer 302 of FIG. 6. The grass gatherer 302 includes one or more fingers 304 that can be connected to a hub or shaft 308 using any suitable technique. Each finger includes one or more tines 306. Such tines 306 can take any suitable shape and have any suitable dimensions. Further, the tines 306 can include any suitable material. The fingers 304 can include any suitable number tines 306 that are oriented in any suitable position relative to a plane 312 in which the finger spins or rotates (i.e., the plane of FIG. 6).

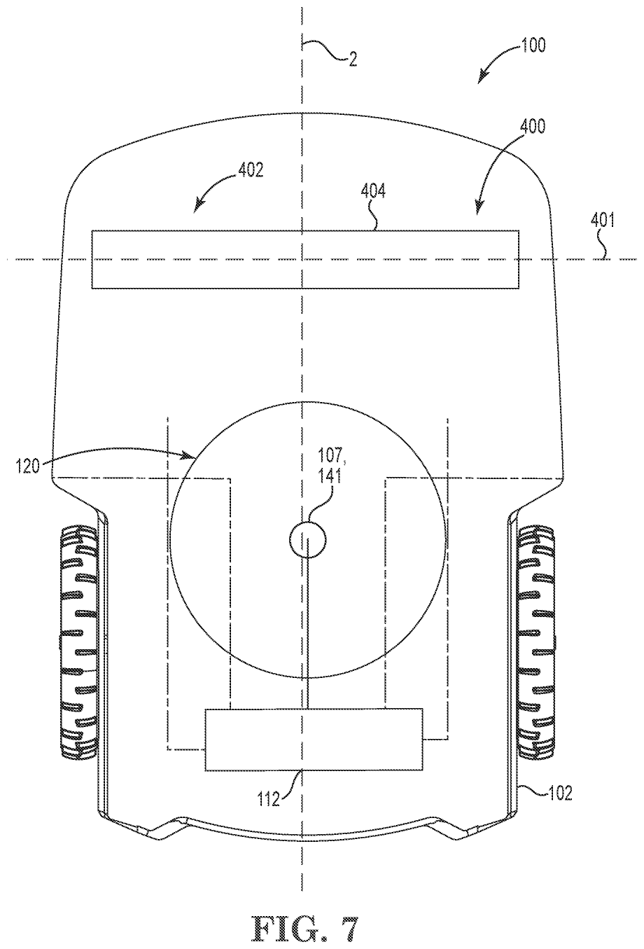

The various embodiments of grass directing systems described herein can also include one or more rollers that are adapted to straighten grass blades. For example, FIG. 7 is a schematic bottom plan view of another embodiment of a mower 100 that includes a grass directing system 400. All design considerations and possibilities described herein regarding grass directing system 200 of FIGS. 3 and 5 apply equally to grass directing system 400 of FIG. 7. The grass directing system 400 includes a grass gatherer 402 that is located forward of the cutting blade assembly 120. The grass gatherer 402 can be operatively connected to a motor (e.g., cutting motor 107 or propulsion motor 104) using any suitable technique. Further, the grass gatherer 402 includes a roller 404 that is adapted to rotate about a roller axis 401. The roller axis 401 can form any suitable angle with the ground surface 101. In one or more embodiments, the roller axis 401 is substantially parallel to the ground surface 101. As used herein, the term “substantially parallel” means that the roller axis 401 forms an angle with the ground surface 101 that is no greater than 8 degrees. Further, the roller axis 401 can form any suitable angle with the longitudinal axis 2 of the housing 102. In one or more embodiments, the roller axis 401 is substantially orthogonal to the longitudinal axis 2. The roller 404 can include any suitable roller or rollers that take any suitable shape and have any suitable dimensions. In one or more embodiments, the roller 404 includes a textured surface that is adapted to assist the grass gatherer 402 in straightening the grass blades 162. Although not shown in FIG. 7, the mower 100 can include grass gatherer 402 and one or more grass gatherers 202 disposed in any suitable relationship to the grass gatherer 402. In one or more embodiments, the grass gatherer 402 is disposed between one or more of the grass gatherers 202 and the front end 134 of the mower 100.

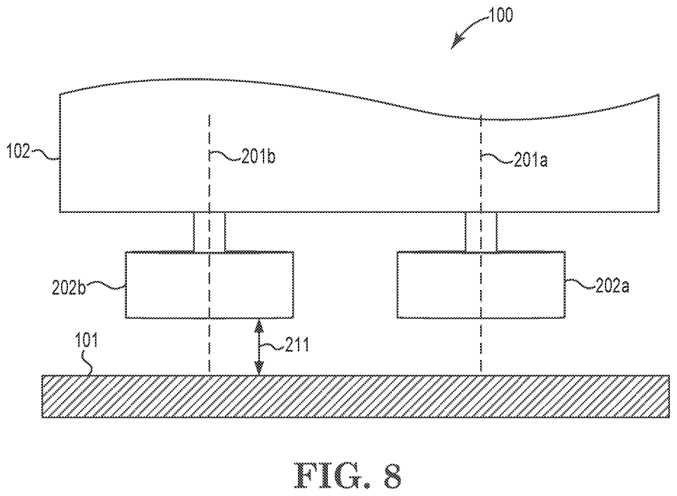

As mentioned herein, the grass directing system 200 can include any suitable grass gatherers 202. As shown in FIG. 8, which is a schematic front view of a portion of the mower 100, the first grass gatherer 202a rotates about the first gatherer axis 201a, and the second grass gatherer 202b rotates about a second gatherer axis 201b. The first gatherer axis 201a can be oriented in any suitable relationship with the second gatherer axis 201b. In one or more embodiments, the first gatherer axis 201a can be substantially parallel to the second gatherer axis 201b. The first and second grass gatherers 202a and 202b can rotate in any suitable direction about their respective axes 201a and 201b. In one or more embodiments, each of the first and second grass gatherers 202a and 202b can rotate in either a first direction or a second direction. For example, the first grass gatherer 202a can be adapted to rotate about the first gatherer axis 201a in a first direction, and the second grass gatherer 202b can be adapted to rotate about the second gatherer axis 201b in a second direction that is different from the first direction. In one or more embodiments, the first and second grass gatherers 202a-b can rotate in the same direction.

The grass gatherers 202 are adapted to engage grass blades 162 as described herein. Such grass gatherers 202 can be adapted to engage grass blades along an engagement path that defines an engagement edge 214 located at a second distance 216 from the longitudinal axis 2 as shown in FIG. 3. In one or more embodiments, the second distance 216 is less than the first distance 140 of the cut edge 155 defined by the cutting path 154 of the cutting blade assembly 120. As a result, in one or more embodiments, the engagement path can overlap with the cutting path 154 defined by the cutting blade assembly 120. In one or more embodiments, the grass gatherers 202 can be adapted to redirect grass 113 that may be outside of the cutting path 154 of the cutting blade assembly 120 within the cutting path such that the assembly can cut the grass.

Each grass gatherer 202 can define an engagement path that can be disposed in any suitable relationship to the cutting path 154 defined by the cutting blade assembly 120. For example, the second grass gatherer 202b can be adapted to engage grass blades 162 along a second engagement path that defines an engagement edge 220 located a third distance 222 from the longitudinal axis 2. In one or more embodiments, the third distance 222 is less than the first distance 140 of the cut edge 155. In one or more embodiments, the second distance 216 is the same as the third distance 222.

In general, the grass gatherers 202 can be electrically or wirelessly connected to the controller 112. In one or more embodiments, the first grass gatherer 202a can be independently controllable, e.g., by the controller 112, from the second grass gatherer 202b. Further, the controller 112 can direct the grass gatherers 202 to rotate in any suitable manner.

At least one of the grass gatherers 202 can be adapted such that a distance or height 211 (FIG. 8) between the grass gatherer and the ground surface 101 is adjustable or selectable. Any suitable technique can be utilized to adjust the height 211 of one or both of the grass gatherers 202. In one or more embodiments, the mower 100 can include a height adjustment motor (not shown) that is operatively connected to at least one of the first grass gatherer 202b or second grass gatherer 202b, where the height adjustment motor is adapted to adjust the height 211 between the respective grass gatherer and the ground surface 101. In one or more embodiments, the controller 112 is adapted to adjust the height 211 of at least one of the grass gatherers 202.

The grass directing system 200 can include any suitable additional components that are adapted to straighten the grass blades 162. For example, as shown in FIG. 3, the grass directing system 200 can include an optional vacuum module 210 that is adapted to further engage the grass blades 162 such that one or more additional grass blades are made to intersect the cutting plane 105 so that the one or more additional grass blades are cut by the cutting blade assembly 120. The vacuum module 210 can include any suitable vacuum or vacuums. Further, the vacuum module 210 can be electrically or wirelessly connected to the controller 112. The vacuum module 210 can be mechanically connected to at least one of the cutting motor 107, propulsion motor 104, or the battery 133 using any suitable technique.

As mentioned herein, the cutting blade assembly 120 can be operatively connected to the propulsion motor 104 or the cutting motor 107 using any suitable technique. Further, the grass directing system 200 can also be operatively connected to propulsion motor 104 or the cutting motor 107. In one or more embodiments, the grass directing system 200 can be operatively connected to an implement motor that is separate from the propulsion motor 104 and the cutting motor 107. Further, in one or more embodiments, the grass directing system 200 can include one or more ground engaging members that are operatively connected to one or more grass gatherers 202 and cause the gathers to rotate about respective gatherer axes 201. In one or more embodiments, the cutting blade assembly 120 and the grass directing system 200 can be independently controllable, e.g., by the controller 112.

Returning to FIG. 2, the mower 100 may further include a power source, which in one embodiment, is the battery 133 having a lithium-based chemistry (e.g., lithium-ion). Other embodiments may utilize batteries of other chemistries, or other power source technologies (e.g., solar power, fuel cell, internal combustion engines) altogether. It is further noted that, while shown as using independent cutting and propulsion motors 107 and 104, such a configuration is illustrative only as embodiments wherein cutting and propulsion power are provided by a single motor are also envisioned.

The mower 100 may further include one or more sensors to provide location data. For instance, some embodiments may include a global positioning system (GPS) receiver 122 (or other position sensor that may provide similar data) that is adapted to estimate a position of the mower 100 within the work region and provide such information to a controller 112 (described herein). In other embodiments, one or more of the wheels 106, 108 may include an encoder 118 that provides wheel rotation/speed information (odometry data) that may be used to estimate mower position (e.g., based upon an initial start position) within the work region. The mower 100 may also include a sensor 115 adapted to detect a boundary wire, which could be used alternatively or in addition to other navigational techniques.

The mower 100 may optionally include one or more front obstacle detection sensors 130 and one or more rear obstacle detection sensors 132, as well as other sensors, such as side obstacle detection sensors (not shown). The obstacle detection sensors 130, 132 may be used to detect an obstacle in the path of the mower 100 when travelling in a forward or reverse direction, respectively. The mower 100 may be capable of mowing while moving in either direction. As illustrated, the sensors 130 and 132 may be located at the front end 134 and the rear end 136 of the mower 100, respectively.

The sensors 130, 132 may use contact sensing, non-contact sensing, or both types of sensing. For example, both contact and non-contact sensing may be enabled concurrently or only one type of sensing may be used depending on the status of the mower 100. One example of contact sensing includes using a contact bumper protruding from the housing 102, or from a shroud forming a part of the housing, that can detect when the mower 100 has contacted the obstacle. Non-contact sensors may use acoustic or light waves to detect the obstacle, sometimes at a distance from the mower 100 before contact with the obstacle (e.g., using infrared, radio detection and ranging (radar), light detection and ranging (lidar), etc.).

In one or more embodiments, the mower 100 may also include one or more vision-based sensors in communication with the controller 112 to provide and/or correct localization data (e.g., position, orientation, and/or velocity), as well as object detection, during mower operation. The vision-based sensors may include one or more cameras 131 that capture and/or record images for use with a vision system. The cameras 131 may be described as part of the vision system of the mower 100. While not limiting, types of images captured may include, for example, training images and/or operating images.

The one or more cameras 131 may be capable of detecting visible light, non-visible light, or both. The one or more cameras 131 may establish a total field of view of at least 30 degrees, at least 45 degrees, at least 60 degrees, at least 90 degrees, at least 120 degrees, at least 180 degrees, at least 270 degrees, or 360 degrees, around the autonomous machine (e.g., mower 100). The field of view may be defined in a horizontal direction, a vertical direction, or both directions. For example, a total horizontal field of view may be 360 degrees, and a total vertical field of view may be 45 degrees. The field of view may capture image data above and below the height of the one or more cameras.

In one or more embodiments, the mower 100 includes four cameras 131. One camera 131 may be positioned in each of one or more of directions including a forward direction, a reverse direction, a first (left) side direction, and a second (right) side direction (e.g., Cardinal directions relative to the mower 100). One or more camera directions may be positioned orthogonal to one or more other cameras 131 or positioned opposite to at least one other camera 131. The cameras 131 may also be offset from any of these directions (e.g., at a 45 degree or another non-right angle).

Sensors of the mower 100 may also be described as either vision-based sensors or non-vision-based sensors. Vision-based sensors may include cameras 131 that are capable of capturing and/or recording images/image data. Non-vision-based sensors may include any sensors that are not cameras 131. For example, wheel encoders 118 that use optical (e.g., photodiode), magnetic, or capacitive sensing to detect wheel revolutions may be described as a non-vision-based sensor. In addition to the sensors described above, other sensors now known or later developed may also be incorporated into the mower 100.

The mower 100 may also include the electronic controller 112 adapted to monitor and control various mower functions. As used herein, the term “controller” may be used to describe electronic components of a “system” that receive inputs and provide commands to control various other components of the system. The exemplary controller 112 has a processor 114 that receives various inputs and executes one or more computer programs or applications stored in memory 116. The memory 116 may include computer-readable instructions or applications that, when executed, e.g., by the processor 114, cause the controller 112 to perform various calculations and/or issue commands. That is to say, the processor 114 and memory 116 may together define a computing apparatus operable to process input data and generate the desired output to one or more components/devices. For example, the processor 114 may receive various input data including positional data from the GPS receiver 122 and/or encoders 118 and generate speed and steering angle commands to the drive wheel motor(s) 104 to cause the drive wheels 106 to rotate (at the same or different speeds and in the same or different directions). In other words, the controller 112 may control the steering angle and speed of the mower 100, as well as the rotation (e.g., speed and operation) of the cutting blade assembly 120.

The controller 112 may use the processor 114 and memory 116 in various different systems, and a processor 114 and memory 116 may be included in each of the different systems. For example, the controller 112 may at least partially define a vision system, which may include a processor 114 and memory 116. The controller 112 may also at least partially define a navigation system, which may also include a processor 114 and memory 116 separate from the processor 114 and memory 116 of the vision system. In one or more embodiments, the vision system can utilize at least one of the cameras 131, sensors 130, 132, grass directing system 200, or cutting blade assembly 120 to determine whether grass in an area is cut to the desired level or height and/or adequately collected before moving to another area. See, e.g., one or more embodiments described in U.S. Pat. No. 10,932,409B2, entitled SYSTEM AND METHOD FOR OPERATING AN AUTONOMOUS ROBOTIC WORKING MACHINE WITHIN A TRAVELLING CONTAINMENT ZONE, and U.S. Pat. No. 11,334,082B2, entitled AUTONOMOUS MACHINE NAVIGATION AND TRAINING USING VISION SYSTEM, which are incorporated herein by reference in their entireties. Still further, the controller 112 may at least partially define an object detection system (e.g., for situational awareness), which may also include a processor 114 and memory 116 separate from the other systems. In yet other embodiments, a single processor 114 and memory 116 may be provide for all the mower systems.

In addition, the mower 100 may include a wireless radio 117 to permit operative communication with a separate device, such as a remote computer 119. The remote computer 119 may permit remote operator interaction with the mower 100/controller 112 when such interaction is beneficial or necessary.

In view of the above, it will be readily apparent that the functionality of the controller 112 may be implemented in any manner known to one skilled in the art. For instance, the memory 116 may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While shown as both being incorporated into the controller 112, the memory 116 and the processor 114 could be contained in separate modules.

The processor 114 may include any one or more of a microprocessor, a controller, a digital signal processor (DSP), an application specific integrated circuit (ASIC), a field-programmable gate array (FPGA), and/or equivalent discrete or integrated logic circuitry. In one or more embodiments, the processor 114 may include multiple components, such as any combination of one or more microprocessors, one or more controllers, one or more DSPs, one or more ASICs, and/or one or more FPGAs, as well as other discrete or integrated logic circuitry. The functions attributed to the controller 112 and/or processor 114 herein may be embodied as software, firmware, hardware, or any combination of these. Certain functionality of the controller 112 may also be performed in the cloud or other distributed computing systems operably connected to the processor 114 (e.g., on the remote computer 119).

In FIG. 2, schematic connections are generally shown between the controller 112 and the battery 133, wheel motor(s) 104, cutting motor 107, optional boundary wire sensor 115, wireless radio 117, and GPS receiver 122. Although not shown in FIG. 2, similar connections can be utilized to connect the grass directing system 200 with at least one of the controller 112 or the battery 133. These interconnections are illustrative only as the various components and subsystems of the mower 100 could be connected in most any manner, e.g., directly to one another, wirelessly, via a bus architecture (e.g., controller area network (CAN) bus), or any other connection configuration that permits data and/or power to pass between the various components of the mower. Although connections with some of the sensors 130, 132, 131 are not shown, these sensors and other components of the mower 100 may be connected in a similar manner. The wireless radio 117 may communicate over a cellular or other wide area network (e.g., over the internet), a local area network (e.g., IEEE 802.11 “Wi-Fi” radio), or a peer-to-peer (P2P) (e.g., BLUETOOTH™) network with the remote computer 119 (e.g., cellular telephone (“smartphone”), tablet, desktop, or wearable computer or server (local or remote)). In turn, the mobile computer 119 may communicate with other devices over similar networks and, for example, may be used to connect the mower 100 to the internet.

In one or more embodiments, various functionality of the controllers 112 described herein may be offloaded from the mower 100. For example, recorded images may be transmitted to a remote server (e.g., internet-connected or “cloud” server) using the wireless radio 117 and processed or stored. The images stored, or other data derived from processing, may be received using the wireless radio 117 and be stored on, or further processed by, the mower 100.

The cutting motor 107 may be attached to the upper wall 111 of the housing 102. Once again, while illustrated herein as an electric motor 107, alternative prime movers, such as internal combustion engines, are also contemplated. Other components, e.g., the battery 133, may also be attached to the housing 102/upper wall 111.

The motor 107 may include an output shaft 141 that extends vertically downward (in FIG. 2) through the upper wall 111 of the housing 102 and into the cutting chamber 109 (FIG. 1). A ground-working tool (e.g., rotatable cutting blade assembly 120) may be supported by the housing 102, e.g., attached to a lower end of the shaft 141 and contained, at least partially, within the cutting chamber 109. While identified herein as a “chamber” 109, the cutting blade assembly 120 may operate irrespective of any “chamber” surrounding it. For example, the cutting blade assembly may operate, at least partially, at an elevation below that of the sidewalls 103.

Illustrative embodiments are described and reference has been made to possible variations of the same. These and other variations, combinations, and modifications will be apparent to those skilled in the art, and it should be understood that the claims are not limited to the illustrative embodiments set forth herein.

1-20. (canceled)

21. An autonomous lawn mower comprising:
a housing comprising a downwardly extending sidewall, wherein the housing extends along a longitudinal axis between a front end and a rear end of the mower;
ground support members adapted to support the housing upon a ground surface of a work region in which the mower operates;
a cutting blade assembly supported by the housing and comprising at least one selectively-activated cutting blade, wherein the cutting blade assembly is adapted to cut grass along a cutting path defining a cut edge located at a first distance measured transversely from the longitudinal axis of the housing; and
a grass directing system located proximate the cutting blade assembly, the grass directing system comprising at least one grass gatherer located forward of the cutting blade assembly, wherein the at least one grass gatherer is adapted to engage grass blades such that one or more of the grass blades are made to intersect a cutting plane defined by the cutting blade assembly and bounded by the cutting path so that the one or more grass blades are cut by the cutting blade assembly, wherein the at least one grass gatherer comprises at least one finger that spins within a plane parallel to the ground surface.

22. The lawn mower of claim 21, wherein the at least one finger comprises at least one of a bristle or a tine.

23. The lawn mower of claim 21, wherein the at least one grass gatherer is adapted to rotate about a gatherer axis.

24. The lawn mower of claim 21, wherein the at least one grass gatherer of the grass directing system comprises a first grass gatherer and a second grass gatherer, wherein the first grass gatherer rotates about a first gatherer axis and the second grass gatherer rotates about a second gatherer axis.

25. The lawn mower of claim 21, wherein the grass directing system further comprises a vacuum module that is adapted to further engage the grass blades such that one or more additional grass blades are made to intersect the cutting plane so that the one or more additional grass blades are cut by the cutting blade assembly.

26. The lawn mower of claim 21, wherein the cutting blade assembly and grass directing system are independently controllable.

27. The lawn mower of claim 21, wherein a height between the at least one grass gatherer and the ground surface is adjustable.

28. The lawn mower of claim 21, wherein the at least one grass gatherer is adapted to redirect grass that is outside of the cutting path of the cutting blade assembly to within the cutting path such that the assembly can cut such grass.

29. A lawn mower comprising:
a housing comprising a downwardly extending sidewall, wherein the housing extends along a longitudinal axis between a front end and a rear end of the lawn mower;
ground support members adapted to support the housing upon a ground surface of a work region in which the mower operates;
a cutting motor connected to the housing;
a cutting blade assembly supported by the housing and operatively connected to the cutting motor, wherein the cutting blade assembly comprises at least one selectively-activated cutting blade, wherein the cutting blade assembly is adapted to cut grass along a cutting path defining a cut edge located at a first distance measured transversely from the longitudinal axis of the housing; and
a grass directing system located proximate the cutting blade assembly and operatively connected to the cutting motor, the grass directing system comprising a first grass gatherer and a second grass gatherer, wherein the first and second grass gatherers are adapted to engage grass blades such that one or more of the grass blades are made to intersect a cutting plane defined by the cutting blade assembly and bounded by the cutting path so that the one or more grass blades are cut by the cutting blade assembly, wherein at least one of the first grass gatherer or second grass gatherer comprises at least one finger that spins within a plane parallel to the ground surface.

30. The lawn mower of claim 29, wherein the at least one finger comprises at least one of a bristle or a tine.

31. The lawn mower of claim 29, wherein the first grass gatherer is adapted to rotate about a first gatherer axis and the second grass gatherer is adapted to rotate about a second gatherer axis.

32. The lawn mower of claim 31, wherein the first grass gatherer rotates about the first gatherer axis in a first direction and the second grass gatherer rotates about the second gatherer axis in a second direction different from the first direction.

33. The lawn mower of claim 29, wherein the ground support members, the cutting blade assembly, and the grass direction system are operatively connected to a propulsion motor.

34. The lawn mower of claim 29, wherein the first grass gatherer is independently controllable from the second grass gatherer.

35. The lawn mower of claim 29, wherein the cutting blade assembly and grass directing system are independently controllable.

36. The lawn mower of claim 29, wherein the first grass gatherer is adapted to engage grass blades along an engagement path defining an engagement edge located at a second distance measured transversely from the longitudinal axis, wherein the second distance is less than the first distance of the cut edge.

37. The lawn mower of claim 36, wherein the second grass gatherer is adapted to engage grass blades along a second engagement path defining an engagement edge located a third distance measured transversely from the longitudinal axis, wherein the third distance is less than the first distance of the cut edge.

38. The lawn mower of claim 29, wherein at least one of the first grass gatherer or second grass gatherer is adapted to redirect grass that is outside of the cutting path of the cutting blade assembly to within the cutting path such that the assembly can cut such grass.
